(19) United States
(12) Patent Application Publication
(10) Pub. No.: US 2026/0088619 A1
(43) Pub. Date: Mar. 26, 2026

(54) METHOD AND SYSTEM FOR UTILIZING WIND ENERGY IN MARICULTURE

(71) Applicant: GUANGDONG OCEAN UNIVERSITY, Zhanjiang (CN)

(72) Inventors: Guanglin WU, Zhanjiang (CN); Huahao YU, Zhanjiang (CN); Wanning HOU, Zhanjiang (CN); Hui YANG, Zhanjiang (CN); Yan TIAN, Zhanjiang (CN); Hongfei MAO, Zhanjiang (CN); Yanli HE, Zhanjiang (CN); Zhenglin TIAN, Zhanjiang (CN); Jinbo LIN, Zhanjiang (CN); Dongbin HE, Zhanjiang (CN); Zhongbing ZHOU, Zhanjiang (CN); Jintao XU, Zhanjiang (CN); Suijun WANG, Zhanjiang (CN)

(21) Appl. No.: 19/409,771

(22) Filed: Dec. 5, 2025

Related U.S. Application Data
(63) Continuation of application No. PCT/CN2025/111059, filed on Jul. 29, 2025.

(30) Foreign Application Priority Data
Aug. 7, 2024 (CN) 202411075066.7

(51) Int. Cl. H02J 3/00; G06Q 50/06

(52) U.S. Cl. CPC H02J 3/003; G06Q 50/06

(57) ABSTRACT

Disclosed are a method and system for utilizing wind energy in mariculture. The method includes performing fitting on a wind energy power time series and a historical actual wind energy power time series, obtaining a historical fitted wind energy power time series, inputting the historical fitted wind energy power time series into a wind energy power prediction model, and outputting a future wind energy power time series; inputting an obtained historical electricity consumption time series into an electricity consumption prediction model, and outputting a future electricity consumption time series; determining a future wind energy power shortage time series; and sequencing all electric devices in an offshore aquaculture platform based on priorities, obtaining an electric device sequence, and generating an electric device electricity consumption distribution strategy based on the future wind energy power shortage time series and the electric device sequence.

### TECHNICAL FIELD

The present disclosure relates to the technical field of energy management, and particularly relates to a method and system for utilizing wind energy in mariculture.

### BACKGROUND

With development of the mariculture industry, dependence on power supply is increasing. The key facilities in offshore aquaculture areas, such as pumps, oxygen supply systems, temperature control devices and lighting systems, all require stable and reliable power to maintain their normal operation. The stable operation of the devices is crucial to a guarantee of health and production efficiency of cultured organisms.

However, power supply in the offshore aquaculture areas faces many challenges. As a renewable energy source, wind energy has great development potential at sea. However, instability and unpredictability of the wind energy have brought difficulties to the power supply in the offshore aquaculture areas. In addition, intermittent output of wind power generators may lead to unstable power supply, affecting operating efficiency of electric devices, and even possibly causing harmful effects on the cultured organisms. In view of this, how to utilize wind energy in the sea area where an aquaculture area is located to implement power distribution in the aquaculture area is a difficult problem at present.

### SUMMARY

A technical problem to be solved by the present disclosure is to provide a method and system for utilizing wind energy in mariculture, which optimize management and scheduling of electric devices and improve energy utilization efficiency.

To solve the technical problem, the present disclosure provides a method for utilizing wind energy in mariculture. The method includes:
calculating a wind energy power time series based on an obtained historical offshore wind speed time series, and meanwhile, obtaining a historical actual wind energy power time series corresponding to the historical offshore wind speed time series;
performing fitting on the wind energy power time series and the historical actual wind energy power time series, obtaining a historical fitted wind energy power time series, inputting the historical fitted wind energy power time series into a pre-trained wind energy power prediction model, and outputting a future wind energy power time series through the wind energy power prediction model;
inputting, based on an obtained historical electricity consumption time series in an offshore aquaculture platform, the historical electricity consumption time series into a pre-trained electricity consumption prediction model, and outputting a future electricity consumption time series through the electricity consumption prediction model;
determining a future wind energy power shortage time series based on the future wind energy power time series and the future electricity consumption time series; and
obtaining priorities of all electric devices in the offshore aquaculture platform, sequencing all the electric devices based on the priorities, obtaining an electric device sequence, and generating an electric device electricity consumption distribution strategy based on the future wind energy power shortage time series and the electric device sequence.

In one possible implementation, the generating an electric device electricity consumption distribution strategy based on the future wind energy power shortage time series and the electric device sequence specifically includes:
determining, based on the future wind energy power shortage time series, a plurality of periods of future wind energy power shortage time and shortage wind energy power corresponding to each period of future wind energy power shortage time;
obtaining an electricity consumption demand corresponding to each of the electric devices in the electric device sequence, and comparing an electricity consumption demand corresponding to a last electric device in the electric device sequence with the shortage wind energy power corresponding to the plurality of periods of future wind energy power shortage time;
obtaining, in a case where the electricity consumption demand corresponding to the last electric device is not less than the shortage wind energy power, target future wind energy power shortage time corresponding to the shortage wind energy power, deleting the last electric device from the electric device sequence, obtaining a first adjusted electric device sequence, and determining an electricity consumption distribution object corresponding to the target future wind energy power shortage time based on the first adjusted electric device sequence; or,
obtaining, in a case where the electricity consumption demand corresponding to the last electric device is less than the shortage wind energy power, an adjacent electric device of the last electric device, calculating a total electricity consumption demand of the last electric device and the adjacent electric device, sequentially increasing, in a case where the total electricity consumption demand is less than the shortage wind energy power, a quantity of the adjacent electric devices until a total electricity consumption demand of the last electric device and a target quantity of adjacent electric devices is not less than the shortage wind energy power, deleting the last electric device and the target quantity of adjacent electric devices from the electric device sequence, obtaining a second adjusted electric device sequence, and determining the electricity consumption distribution object corresponding to the target future wind energy power shortage time based on the second adjusted electric device sequence.

In one possible implementation, the calculating a wind energy power time series based on an obtained historical offshore wind speed time series specifically includes:
obtaining a plurality of historical offshore wind speeds in a preset historical time period, and arranging the plurality of historical offshore wind speeds in a time sequence, to obtain the historical offshore wind speed time series;
separately inputting each of the historical offshore wind speeds in the historical offshore wind speed time series into a preset wind energy density calculation formula, obtaining a historical offshore wind energy density corresponding to each of the historical offshore wind speeds, and generating a historical offshore wind energy density time series corresponding to the historical offshore wind speed time series; and
extracting a target historical offshore wind energy density corresponding to a historical time point from the historical offshore wind energy density time series, extracting a target historical offshore wind speed corresponding to the historical time point from the historical offshore wind speed time series, substituting the target historical offshore wind energy density and the target historical offshore wind speed into a preset wind energy power calculation formula, obtaining wind energy power corresponding to the historical time point, and generating a wind energy power time series based on the wind energy power corresponding to the historical time point.

In one possible implementation, the wind energy density calculation formula is shown as follows:

$$W = {rAv}^{3} / 2.$$

In the formula, W denotes an offshore wind energy density, r denotes an air density, A denotes a swept area of a wind turbine blade, and v denotes an offshore wind speed.

The wind energy power calculation formula is shown as follows:

$$P = WsA .$$

In the formula, P denotes the wind energy power, W denotes the offshore wind energy density, s denotes conversion efficiency of a wind energy converter, and A denotes the swept area of the wind turbine blade.

In one possible implementation, the performing fitting on the wind energy power time series and the historical actual wind energy power time series, and obtaining a historical fitted wind energy power time series specifically include:
calculating total wind energy power corresponding to the wind energy power time series, and calculating average wind energy power corresponding to the wind energy power time series based on a wind energy power data point quantity in the wind energy power time series and the total wind energy power;
calculating total historical actual wind energy power corresponding to the historical actual wind energy power time series, and calculating average historical actual wind energy power corresponding to the historical actual wind energy power time series based on a wind energy power data point quantity in the historical actual wind energy power time series and the total historical actual wind energy power;
calculating a first difference between the average wind energy power and the average historical actual wind energy power, averaging, in a case where the first difference is not greater than a preset difference threshold, the wind energy power time series and the historical actual wind energy power time series, and obtaining the historical fitted wind energy power time series; or,
performing, in a case where the first difference is greater than the preset difference threshold, weighted average processing on the wind energy power time series and the historical actual wind energy power time series, and obtaining the historical fitted wind energy power time series.

In one possible implementation, a training process of the wind energy power prediction model specifically includes:
setting an initial wind energy power prediction model, where the initial wind energy power prediction model includes a first prediction layer and a second prediction layer, and the first prediction layer is connected to the second prediction layer;
obtaining wind energy power time series samples corresponding to identical days in a plurality of preset historical years and a meteorological time series sample corresponding to each of the wind energy power time series samples; and
using the wind energy power time series sample corresponding to a first preset year as input of the first prediction layer, and using the meteorological time series sample corresponding to a second preset year as output of the first prediction layer; and using the output of the first prediction layer as output of the second prediction layer, using the wind energy power time series sample corresponding to the second preset year as the output of the second prediction layer, performing model training on the initial wind energy power prediction model until the model converges or reaches a preset iteration number, and obtaining the wind energy power prediction model. The second preset year is a next year of the first preset year.

In one possible implementation, the determining a future wind energy power shortage time series based on the future wind energy power time series and the future electricity consumption time series specifically includes:
extracting target future wind energy power and target future electricity consumption corresponding to each target time point from the future wind energy power time series and the future electricity consumption time series, and separately comparing the target future wind energy power and the target future electricity consumption corresponding to an identical target time point;
calculating, in a case where the target future wind energy power is less than the target future electricity consumption, a wind energy power shortage value based on the target future wind energy power and the target future electricity consumption, and using the wind energy power shortage value as a sequence value corresponding to a current time point;
calculating, in a case where the target future wind energy power is not less than the target future electricity consumption, a wind energy power adequacy value based on the target future wind energy power and the target future electricity consumption, and using the wind energy power adequacy value as the sequence value corresponding to the current time point;
integrating sequence values corresponding to all target time points to obtain a wind energy power surplus-deficit time series, traversing each sequence value in the wind energy power surplus-deficit time series one by one, and retaining, in a case where the sequence value that is the wind energy power shortage value is traversed and no wind energy power adequacy value exists before the wind energy power shortage value, the wind energy power shortage value; and
obtaining, in a case where the sequence value that is the wind energy power shortage value is traversed and the wind energy power adequacy value exists before the wind energy power shortage value, the wind energy power adequacy value before the wind energy power shortage value, adjusting the wind energy power shortage value based on the wind energy power adequacy value, obtaining an adjusted sequence value, and determining the future wind energy power shortage time series until traversing of the wind energy power surplus-deficit time series is completed.

In one possible implementation, the obtaining priorities of all electric devices in the offshore aquaculture platform specifically includes:
obtaining respective use degrees of all the electric devices, and setting respective first weight values for all the electric devices based on the use degrees;
obtaining all first electric devices having an identical initial weight value, and setting respective second weight values for all the first electric devices based on respective electricity consumption demands of all the first electric devices; and
determining the respective priorities of all the electric devices based on the first weight values and the second weight values.

The present disclosure further provides a system for utilizing wind energy in mariculture. The system includes a wind energy power time series obtainment module, a future wind energy power time series prediction module, a future electricity consumption time series prediction module, a future wind energy power shortage time series determination module, and an electric device electricity consumption distribution strategy generation module.

The wind energy power time series obtainment module is configured to calculate a wind energy power time series based on an obtained historical offshore wind speed time series, and meanwhile, obtain a historical actual wind energy power time series corresponding to the historical offshore wind speed time series.

The future wind energy power time series prediction module is configured to perform fitting on the wind energy power time series and the historical actual wind energy power time series, obtain a historical fitted wind energy power time series, input the historical fitted wind energy power time series into a pre-trained wind energy power prediction model, and output a future wind energy power time series through the wind energy power prediction model.

The future electricity consumption time series prediction module is configured to input, based on an obtained historical electricity consumption time series in an offshore aquaculture platform, the historical electricity consumption time series into a pre-trained electricity consumption prediction model, and output a future electricity consumption time series through the electricity consumption prediction model.

The future wind energy power shortage time series determination module is configured to determine a future wind energy power shortage time series based on the future wind energy power time series and the future electricity consumption time series.

The electric device electricity consumption distribution strategy generation module is configured to obtain priorities of all electric devices in the offshore aquaculture platform, sequence all the electric devices based on the priorities, obtain an electric device sequence, and generate an electric device electricity consumption distribution strategy based on the future wind energy power shortage time series and the electric device sequence.

In one possible implementation, the electric device electricity consumption distribution strategy generation module is configured to generate the electric device electricity consumption distribution strategy based on the future wind energy power shortage time series and the electric device sequence, and specifically:
determine, based on the future wind energy power shortage time series, a plurality of periods of future wind energy power shortage time and shortage wind energy power corresponding to each period of future wind energy power shortage time;
obtain an electricity consumption demand corresponding to each of the electric devices in the electric device sequence, and compare an electricity consumption demand corresponding to a last electric device in the electric device sequence with the shortage wind energy power corresponding to the plurality of periods of future wind energy power shortage time;
obtain, in a case where the electricity consumption demand corresponding to the last electric device is not less than the shortage wind energy power, target future wind energy power shortage time corresponding to the shortage wind energy power, delete the last electric device from the electric device sequence, obtain a first adjusted electric device sequence, and determine an electricity consumption distribution object corresponding to the target future wind energy power shortage time based on the first adjusted electric device sequence; or,
obtain, in a case where the electricity consumption demand corresponding to the last electric device is less than the shortage wind energy power, an adjacent electric device of the last electric device, calculate a total electricity consumption demand of the last electric device and the adjacent electric device, sequentially increase, in a case where the total electricity consumption demand is less than the shortage wind energy power, a quantity of the adjacent electric devices until a total electricity consumption demand of the last electric device and a target quantity of adjacent electric devices is not less than the shortage wind energy power, delete the last electric device and the target quantity of adjacent electric devices from the electric device sequence, obtain a second adjusted electric device sequence, and determine the electricity consumption distribution object corresponding to the target future wind energy power shortage time based on the second adjusted electric device sequence.

In one possible implementation, the wind energy power time series obtainment module is configured to calculate a wind energy power time series based on an obtained historical offshore wind speed time series, and specifically:
obtain a plurality of historical offshore wind speeds in a preset historical time period, and arrange the plurality of historical offshore wind speeds in a time sequence, to obtain the historical offshore wind speed time series;
separately input each of the historical offshore wind speeds in the historical offshore wind speed time series into a preset wind energy density calculation formula, obtain a historical offshore wind energy density corresponding to each of the historical offshore wind speeds, and generate a historical offshore wind energy density time series corresponding to the historical offshore wind speed time series; and
extract a target historical offshore wind energy density corresponding to a historical time point from the historical offshore wind energy density time series, extract a target historical offshore wind speed corresponding to the historical time point from the historical offshore wind speed time series, substitute the target historical offshore wind energy density and the target historical offshore wind speed into a preset wind energy power calculation formula, obtain wind energy power corresponding to the historical time point, and generate a wind energy power time series based on the wind energy power corresponding to the historical time point.

In one possible implementation, the wind energy density calculation formula is shown as follows:

$$W = {rAv}^{3} / 2.$$

In the formula, W denotes an offshore wind energy density, r denotes an air density, A denotes a swept area of a wind turbine blade, and v denotes an offshore wind speed.

The wind energy power calculation formula is shown as follows:

$$P = WsA .$$

In the formula, P denotes the wind energy power, W denotes the offshore wind energy density, s denotes conversion efficiency of a wind energy converter, and A denotes the swept area of the wind turbine blade.

In one possible implementation, the future wind energy power time series prediction module is configured to perform fitting on the wind energy power time series and the historical actual wind energy power time series, and obtain the historical fitted wind energy power time series, and specifically:
calculate total wind energy power corresponding to the wind energy power time series, and calculate average wind energy power corresponding to the wind energy power time series based on a wind energy power data point quantity in the wind energy power time series and the total wind energy power;
calculate total historical actual wind energy power corresponding to the historical actual wind energy power time series, and calculate average historical actual wind energy power corresponding to the historical actual wind energy power time series based on a wind energy power data point quantity in the historical actual wind energy power time series and the total historical actual wind energy power;
calculate a first difference between the average wind energy power and the average historical actual wind energy power, average, in a case where the first difference is not greater than a preset difference threshold, the wind energy power time series and the historical actual wind energy power time series, and obtain the historical fitted wind energy power time series; or,
perform, in a case where the first difference is greater than the preset difference threshold, weighted average processing on the wind energy power time series and the historical actual wind energy power time series, and obtain the historical fitted wind energy power time series.

In one possible implementation, a training process of the wind energy power prediction model specifically includes:
setting an initial wind energy power prediction model, where the initial wind energy power prediction model includes a first prediction layer and a second prediction layer, and the first prediction layer is connected to the second prediction layer;
obtaining wind energy power time series samples corresponding to identical days in a plurality of preset historical years and a meteorological time series sample corresponding to each of the wind energy power time series samples; and
using the wind energy power time series sample corresponding to a first preset year as input of the first prediction layer, and using the meteorological time series sample corresponding to a second preset year as output of the first prediction layer; and using the output of the first prediction layer as output of the second prediction layer, using the wind energy power time series sample corresponding to the second preset year as the output of the second prediction layer, performing model training on the initial wind energy power prediction model until the model converges or reaches a preset iteration number, and obtaining the wind energy power prediction model. The second preset year is a next year of the first preset year.

In one possible implementation, the future wind energy power shortage time series determination module is configured to determine the future wind energy power shortage time series based on the future wind energy power time series and the future electricity consumption time series, and specifically:
extract target future wind energy power and target future electricity consumption corresponding to each target time point from the future wind energy power time series and the future electricity consumption time series, and separately compare the target future wind energy power and the target future electricity consumption corresponding to an identical target time point;
calculate, in a case where the target future wind energy power is less than the target future electricity consumption, a wind energy power shortage value based on the target future wind energy power and the target future electricity consumption, and use the wind energy power shortage value as a sequence value corresponding to a current time point;
calculate, in a case where the target future wind energy power is not less than the target future electricity consumption, a wind energy power adequacy value based on the target future wind energy power and the target future electricity consumption, and use the wind energy power adequacy value as the sequence value corresponding to the current time point;
integrate sequence values corresponding to all target time points to obtain a wind energy power surplus-deficit time series, traverse each sequence value in the wind energy power surplus-deficit time series one by one, and retain, in a case where the sequence value that is the wind energy power shortage value is traversed and no wind energy power adequacy value exists before the wind energy power shortage value, the wind energy power shortage value; and
obtain, in a case where the sequence value that is the wind energy power shortage value is traversed and the wind energy power adequacy value exists before the wind energy power shortage value, the wind energy power adequacy value before the wind energy power shortage value, adjust the wind energy power shortage value based on the wind energy power adequacy value, obtain an adjusted sequence value, and determine the future wind energy power shortage time series until traversing of the wind energy power surplus-deficit time series is completed.

In one possible implementation, the electric device electricity consumption distribution strategy generation module is configured to obtain the priorities of all the electric devices in the offshore aquaculture platform, and specifically:
obtain respective use degrees of all the electric devices, and set respective first weight values for all the electric devices based on the use degrees;
obtain all first electric devices having an identical initial weight value, and set respective second weight values for all the first electric devices based on respective electricity consumption demands of all the first electric devices; and
determine the respective priorities of all the electric devices based on the first weight values and the second weight values.

The present disclosure further provides a terminal device. The terminal device includes a processor, a memory, and a computer program stored in the memory and configured to be executed by the processor. When the processor executes the computer program, the method for utilizing wind energy in mariculture according to any one of the implementations is implemented.

The present disclosure further provides a computer-readable storage medium. The computer-readable storage medium includes a stored computer program. At runtime, the computer program controls a device where the computer-readable storage medium is located to execute the method for utilizing wind energy in mariculture according to any one of the implementations.

Compared with the prior art, the method and system for utilizing wind energy in mariculture according to the embodiments of the present disclosure have the following beneficial effects:

By predicting the future wind energy power time series and the future electricity consumption time series, a possible wind energy power shortage time period can be predicted in advance. In addition, all the electric devices on the offshore platform are sequenced based on the priorities to obtain the electric device sequence. Based on the future wind energy power shortage time series and the electric device sequence, the electric device electricity consumption distribution strategy is generated, and the electric device electricity consumption distribution strategy is dynamically adjusted based on preset future wind energy power shortage data. In this way, predictable wind energy resources can be utilized more effectively, such that reduction in energy waste can be facilitated, and energy utilization efficiency can be improved. The combination of priority management and wind energy power prediction can ensure that power is supplied to a key electric device first in a case where wind energy resources are insufficient, and optimize management and scheduling of the electric devices, thus satisfying demands of aquaculture activities to the greatest extent.

### BRIEF DESCRIPTION OF THE DRAWINGS

FIG. 1 is a schematic flowchart of an embodiment of a method for utilizing wind energy in mariculture according to the present disclosure.

FIG. 2 is a schematic structural diagram of an embodiment of a system for utilizing wind energy in mariculture according to the present disclosure.

FIG. 3 is a schematic structural diagram of a terminal device according to the present disclosure.

### DETAILED DESCRIPTION OF THE EMBODIMENTS

Technical solutions of embodiments of the present disclosure will be clearly and completely described below in conjunction with accompanying drawings in the present disclosure. Obviously, the embodiments described are merely some embodiments rather than all embodiments of the present disclosure. Based on the embodiments of the present disclosure, all other embodiments obtained by those of ordinary skill in the art without making creative efforts fall within the protection scope of the present disclosure.

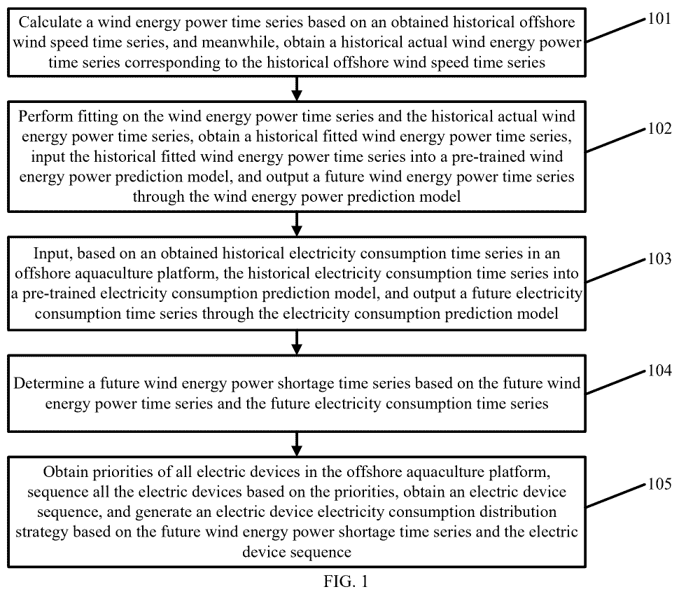

In Embodiment 1, with reference to FIG. 1, FIG. 1 is a schematic flowchart of an embodiment of a method for utilizing wind energy in mariculture according to the present disclosure. As shown in FIG. 1, the method includes step 101 to step 105, which are specifically as follows:

Step 101: a wind energy power time series is calculated based on an obtained historical offshore wind speed time series, and meanwhile, a historical actual wind energy power time series corresponding to the historical offshore wind speed time series is obtained.

In one embodiment, a plurality of historical offshore wind speeds in a preset historical time period are obtained, and the plurality of historical offshore wind speeds are arranged in a time sequence, to obtain the historical offshore wind speed time series.

Preferably, the historical offshore wind speeds are obtained from meteorological stations, buoys, or remote sensing data of satellites. 24 hours in a historical day is regarded as the preset historical time period. The historical day is a day of a last year corresponding to an identical day in a current year.

Specifically, the collected historical offshore wind speeds are arranged in the time sequence to form the historical offshore wind speed time series.

In one embodiment, each of the historical offshore wind speeds in the historical offshore wind speed time series is separately input into a preset wind energy density calculation formula, a historical offshore wind energy density corresponding to each of the historical offshore wind speeds is obtained, and a historical offshore wind energy density time series corresponding to the historical offshore wind speed time series is generated.

Specifically, the wind energy density calculation formula is shown as follows:

$$W = {rAv}^{3} / 2.$$

In the formula, W denotes an offshore wind energy density, r denotes an air density, A denotes a swept area of a wind turbine blade, and v denotes an offshore wind speed.

Specifically, the calculated historical offshore wind energy densities are arranged in the time sequence to generate the historical offshore wind energy density time series.

In one embodiment, a target historical offshore wind energy density corresponding to a historical time point is extracted from the historical offshore wind energy density time series, a target historical offshore wind speed corresponding to the historical time point is extracted from the historical offshore wind speed time series, the target historical offshore wind energy density and the target historical offshore wind speed are substituted into a preset wind energy power calculation formula, wind energy power corresponding to the historical time point is obtained, and a wind energy power time series is generated based on the wind energy power corresponding to the historical time point.

Specifically, the wind energy power calculation formula is shown as follows:

$$P = WsA .$$

In the formula, P denotes the wind energy power, W denotes the offshore wind energy density, s denotes conversion efficiency of a wind energy converter, and A denotes the swept area of the wind turbine blade.

Specifically, the calculated wind energy power is arranged in the time sequence to generate the wind energy power time series.

Step 102: fitting is performed on the wind energy power time series and the historical actual wind energy power time series, a historical fitted wind energy power time series is obtained, the historical fitted wind energy power time series is input into a pre-trained wind energy power prediction model, and a future wind energy power time series is output through the wind energy power prediction model.

In one embodiment, total wind energy power corresponding to the wind energy power time series is calculated, and average wind energy power corresponding to the wind energy power time series is calculated based on a wind energy power data point quantity in the wind energy power time series and the total wind energy power.

Specifically, the sum of all data points in the wind energy power time series is calculated to obtain the total wind energy power, and the obtained total wind energy power is divided by the wind energy power data point quantity in the wind energy power time series, to obtain the average wind energy power.

In one embodiment, total historical actual wind energy power corresponding to the historical actual wind energy power time series is calculated, and average historical actual wind energy power corresponding to the historical actual wind energy power time series is calculated based on a wind energy power data point quantity in the historical actual wind energy power time series and the total historical actual wind energy power.

Specifically, the sum of all data points in the historical actual wind energy power time series is calculated to obtain the total historical actual wind energy power, and the obtained total historical actual wind energy power is divided by the wind energy power data point quantity in the historical actual wind energy power time series, to obtain the average historical actual wind energy power.

In one embodiment, a first difference between the average wind energy power and the average historical actual wind energy power is calculated, in a case where the first difference is not greater than a preset difference threshold, the wind energy power time series and the historical actual wind energy power time series are averaged, and the historical fitted wind energy power time series is obtained.

Specifically, when the wind energy power time series and the historical actual wind energy power time series are averaged, average values of two data points corresponding to the wind energy power time series and the historical actual wind energy power time series are calculated, and the historical fitted wind energy power time series is generated based on the average value corresponding to each of the data points.

In one embodiment, in a case where the first difference is greater than the preset difference threshold, weighted average processing is performed on the wind energy power time series and the historical actual wind energy power time series, and the historical fitted wind energy power time series is obtained.

Specifically, a first weighting factor is set for the wind energy power time series, and a second weighting factor is set for the historical actual wind energy power time series. Each data point in the wind energy power time series is multiplied by the first weighting factor to obtain a first wind energy power time series. Each data point in the historical actual wind energy power time series is multiplied by the second weighting factor to obtain a first historical actual wind energy power time series. The first wind energy power time series and the first historical actual wind energy power time series are added together to obtain the historical fitted wind energy power time series.

In one embodiment, in a training process of the wind energy power prediction model, an initial wind energy power prediction model is set. The initial wind energy power prediction model includes a first prediction layer and a second prediction layer. The first prediction layer is connected to the second prediction layer. Wind energy power time series samples corresponding to identical days in a plurality of preset historical years and a meteorological time series sample corresponding to each of the wind energy power time series samples are obtained. The wind energy power time series sample corresponding to a first preset year is used as input of the first prediction layer, and the meteorological time series sample corresponding to a second preset year is used as output of the first prediction layer. The output of the first prediction layer is used as output of the second prediction layer, and the wind energy power time series sample corresponding to the second preset year is used as the output of the second prediction layer. Model training is performed on the initial wind energy power prediction model until the model converges or reaches a preset iteration number, and the wind energy power prediction model is obtained. The second preset year is a next year of the first preset year.

Specifically, after the wind energy power time series samples corresponding to the identical days in the plurality of preset historical years and the meteorological time series sample corresponding to each of the wind energy power time series samples are obtained, data preprocessing is performed on the wind energy power time series samples and the meteorological time series samples. The data preprocessing includes cleaning, standardization, or normalization, and ensures consistent data formats.

Specifically, after the wind energy power time series samples corresponding to the identical days in the plurality of preset historical years and the meteorological time series sample corresponding to each of the wind energy power time series samples are obtained, the first preset year is randomly selected from the plurality of preset historical years, and the next year of the first preset year is selected as the second preset year based on the first preset year; and the meteorological time series sample corresponding to the second preset year is used as a first label of the wind energy power time series sample in the first preset year, and meanwhile, the wind energy power time series sample corresponding to the second preset year is used as a second label of the meteorological time series sample corresponding to the second preset year.

Specifically, after the initial wind energy power prediction model is set, model initialization is performed on the initial wind energy power prediction model. The model initialization includes the following step that initial values of a weight and a bias term of the model are set, where initialization is generally performed through small random numbers or zero.

Specifically, when model training is performed on the initial wind energy power prediction model, the wind energy power time series sample corresponding to the first preset year is used as the input of the first prediction layer. The first prediction layer processes input data, extracts features, and uses the features as the output. In addition, the output of the first prediction layer is transmitted to the second prediction layer. The second prediction layer generates a predicted value of the wind energy power according to the features. A loss value between the predicted value output by the second prediction layer and an actual wind energy power time series sample is calculated based on a preset loss function. According to the loss function, the weight and the bias term of the model are updated through a back propagation algorithm, to reduce prediction errors. The above process is repeated until the model converges or reaches the preset iteration number.

Preferably, the loss function is mean squared error (MSE) or root mean square error (RMSE).

In one embodiment, the historical fitted wind energy power time series is input into the pre-trained wind energy power prediction model, such that when the wind energy power prediction model outputs the future wind energy power time series, the historical fitted wind energy power time series is input into the first prediction layer of the wind energy power prediction model. In this way, the first prediction layer outputs a future meteorological time series corresponding to the historical fitted wind energy power time series, and the future meteorological time series is used as the input of the second prediction layer, such that the second prediction layer outputs the future wind energy power time series.

Step 103: based on an obtained historical electricity consumption time series in an offshore aquaculture platform, the historical electricity consumption time series is input into a pre-trained electricity consumption prediction model, and a future electricity consumption time series is output through the electricity consumption prediction model.

In one embodiment, in a training process of the electricity consumption prediction model, an initial electricity consumption prediction model is set, and electricity consumption time series samples corresponding to identical days in the plurality of preset historical years are obtained. Based on the plurality of preset historical years, the first preset year and the second preset year adjacent to each other are determined. The electricity consumption time series sample corresponding to the second preset year is set as a label of the electricity consumption time series sample corresponding to the first preset year. The electricity consumption time series sample corresponding to the first preset year is used as input of the initial electricity consumption prediction model, and the label of the electricity consumption time series sample corresponding to the first preset year is used as output of the model. Model training is performed on the initial electricity consumption prediction model until the model converges or reaches a preset iteration number, and the electricity consumption prediction model is obtained. The second preset year is the next year of the first preset year.

In one embodiment, the historical electricity consumption time series is input into the pre-trained electricity consumption prediction model, and the future electricity consumption time series is output through the electricity consumption prediction model. The future electricity consumption time series is an electricity consumption time series of a next year of a year corresponding to the historical electricity consumption time series.

Preferably, the historical electricity consumption time series is an electricity consumption time series corresponding to a last year of the current year.

Step 104: a future wind energy power shortage time series is determined based on the future wind energy power time series and the future electricity consumption time series.

In one embodiment, target future wind energy power and target future electricity consumption corresponding to each target time point are extracted from the future wind energy power time series and the future electricity consumption time series.

In one embodiment, the target future wind energy power and the target future electricity consumption corresponding to an identical target time point are separately compared.

In one embodiment, in a case where the target future wind energy power is less than the target future electricity consumption, a wind energy power shortage value is calculated based on the target future wind energy power and the target future electricity consumption, and the wind energy power shortage value is used as a sequence value corresponding to a current time point.

Specifically, when the wind energy power shortage value is calculated based on the target future wind energy power and the target future electricity consumption, the target future wind energy power is subtracted from the target future electricity consumption, to obtain the wind energy power shortage value.

In one embodiment, in a case where the target future wind energy power is not less than the target future electricity consumption, a wind energy power adequacy value is calculated based on the target future wind energy power and the target future electricity consumption, and the wind energy power adequacy value is used as the sequence value corresponding to the current time point.

Specifically, when the wind energy power adequacy value is calculated based on the target future wind energy power and the target future electricity consumption, the target future electricity consumption is subtracted from the target future wind energy power, to obtain the wind energy power adequacy value.

In one embodiment, sequence values corresponding to all target time points are integrated to obtain a wind energy power surplus-deficit time series, each sequence value in the wind energy power surplus-deficit time series is traversed one by one, and in a case where the sequence value that is the wind energy power shortage value is traversed and no wind energy power adequacy value exists before the wind energy power shortage value, the wind energy power shortage value is retained.

Specifically, when each sequence value in the wind energy power surplus-deficit time series is traversed one by one, if a current sequence value is the wind energy power shortage value and no wind energy power adequacy value exists before the sequence value, the sequence value is retained.

In one embodiment, in a case where the sequence value that is the wind energy power shortage value is traversed and the wind energy power adequacy value exists before the wind energy power shortage value, the wind energy power adequacy value before the wind energy power shortage value is obtained, the wind energy power shortage value is adjusted based on the wind energy power adequacy value, an adjusted sequence value is obtained, and the future wind energy power shortage time series is determined until traversing of the wind energy power surplus-deficit time series is completed.

Specifically, all wind energy power adequacy values before the wind energy power shortage value are obtained, a total wind energy power adequacy value corresponding to all the wind energy power adequacy values is calculated, and the total wind energy power adequacy value is compared with the wind energy power shortage value. If the total wind energy power adequacy value is less than the wind energy power shortage value, a shortage difference between the total wind energy power adequacy value and the wind energy power shortage value is calculated, and the wind energy power shortage value is set as the shortage difference. If the total wind energy power adequacy value is not less than the wind energy power shortage value, an adequacy difference between the total wind energy power adequacy value and the wind energy power shortage value is calculated, the wind energy power shortage value is set as 0, and all the wind energy power adequacy values before the wind energy power shortage value are adjusted based on the adequacy difference.

Specifically, when all the wind energy power adequacy values before the wind energy power shortage value are adjusted based on the adequacy difference, the wind energy power adequacy value before the wind energy power shortage value is set as the adequacy difference, and the wind energy power adequacy value exceeding the adequacy difference is set as 0.

Step 105: priorities of all electric devices in the offshore aquaculture platform are obtained, all the electric devices are sequenced based on the priorities, an electric device sequence is obtained, and an electric device electricity consumption distribution strategy is generated based on the future wind energy power shortage time series and the electric device sequence.

In one embodiment, respective use degrees of all the electric devices are obtained, and respective first weight values are set for all the electric devices based on the use degrees. All first electric devices having an identical initial weight value are obtained, and respective second weight values are set for all the first electric devices based on respective electricity consumption demands of all the first electric devices. The respective priorities of all the electric devices are determined based on the first weight values and the second weight values.

Specifically, device information of all the electric devices in the offshore aquaculture platform is collected. The device information includes use frequency of the devices. Based on the use frequency of the devices, the respective use degrees of all the electric devices are determined.

Specifically, according to the use degree of each of the electric devices, one first weight value is allocated to each of the electric devices. The first weight value is in direct proportion to the use degree.

Specifically, all the electric devices are classified based on the first weight values to obtain a set of a plurality of electric devices having an identical first weight value. That is, the set of electric devices is all the first electric devices having the identical initial weight value.

Specifically, the device information further includes the electricity consumption demands. Based on the device information, the respective electricity consumption demands of all the first electric devices having the identical initial weight value are directly determined, and one second weight value is allocated to each of the electric devices according to the electricity consumption demand corresponding to each of the first electric devices. The second weight value is inversely proportional to the electricity consumption demand.

Specifically, the first weight value and the second weight value are added together to obtain a comprehensive weight value, and the comprehensive weight value is used as the corresponding priority of each of the electric devices.

In one embodiment, all the electric devices are sequenced in a priority order from large to small, to obtain the electric device sequence.

In one embodiment, based on the future wind energy power shortage time series, a plurality of periods of future wind energy power shortage time and shortage wind energy power corresponding to each period of future wind energy power shortage time are determined. Based on this, wind energy power shortage of each future time point is determined.

In one embodiment, an electricity consumption demand corresponding to each of the electric devices in the electric device sequence is obtained.

In one embodiment, an electricity consumption demand corresponding to a last electric device in the electric device sequence is compared with the shortage wind energy power corresponding to the plurality of periods of future wind energy power shortage time.

In one embodiment, in a case where the electricity consumption demand corresponding to the last electric device is not less than the shortage wind energy power, target future wind energy power shortage time corresponding to the shortage wind energy power is obtained, the last electric device is deleted from the electric device sequence, a first adjusted electric device sequence is obtained, and an electricity consumption distribution object corresponding to the target future wind energy power shortage time is determined based on the first adjusted electric device sequence.

Preferably, the first adjusted electric device sequence includes no last electric device.

Specifically, the electric device sequence is determined in a certain priority order. The last electric device has a lowest priority. Thus, when a demand of the last electric device is not less than the shortage wind energy power, a device that needs less or no power supply may be directly determined. In this way, a decision-making process is simplified, and the setting allows a system to dynamically adjust the electric device sequence according to real-time data to adapt to a changing power supply situation.

In one embodiment, in a case where the electricity consumption demand corresponding to the last electric device is less than the shortage wind energy power, an adjacent electric device of the last electric device is obtained, and a total electricity consumption demand of the last electric device and the adjacent electric device is calculated. In a case where the total electricity consumption demand is less than the shortage wind energy power, a quantity of the adjacent electric devices is sequentially increased until a total electricity consumption demand of the last electric device and a target quantity of adjacent electric devices is not less than the shortage wind energy power, the last electric device and the target quantity of adjacent electric devices are deleted from the electric device sequence, a second adjusted electric device sequence is obtained, and the electricity consumption distribution object corresponding to the target future wind energy power shortage time is determined based on the second adjusted electric device sequence.

Specifically, in a case where the electricity consumption demand corresponding to the last electric device is less than the shortage wind energy power, the total electricity consumption demand of the last electric device and the adjacent electric device is calculated. In a case where the total electricity consumption demand is less than the shortage wind energy power, the quantity of the adjacent electric devices is sequentially increased until the calculated total electricity consumption demand is not less than the shortage wind energy power. The last electric device and the target quantity of adjacent electric devices are deleted from the electric device sequence, and the second adjusted electric device sequence is obtained.

Preferably, the second adjusted electric device sequence does not include the last electric device and one or more adjacent electric devices.

In one embodiment, the electricity consumption distribution objects corresponding to all periods of target future wind energy power shortage time are integrated, such that an electricity consumption distribution object time series is obtained. In addition, the electricity consumption distribution time series is used as the electric device electricity consumption distribution strategy.

In one embodiment, an electricity consumption demand of the last electric device is compared with the shortage wind energy power, such that which device may be considered to undergo reduction or stopping of power supply first during power shortage may be determined. In this way, resource allocation is optimized, and rationality and effectiveness of power supply in a case of wind energy power shortage are ensured. Moreover, during power shortage, impact on a power grid can be reduced and stability of the power grid can be maintained by gradually reducing a quantity of electric devices without one-time large-scale reduction.

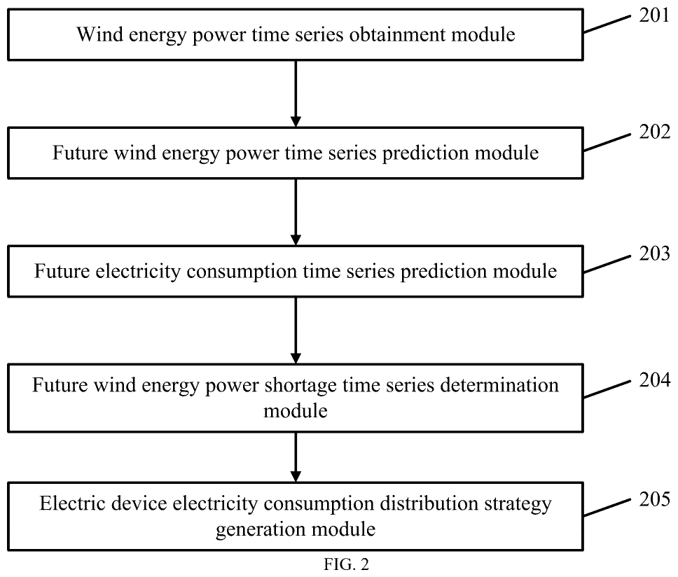

In Embodiment 2, with reference to FIG. 2, FIG. 2 is a schematic structural diagram of an embodiment of a system for utilizing wind energy in mariculture according to the present disclosure. As shown in FIG. 2, the system includes a wind energy power time series obtainment module 201, a future wind energy power time series prediction module 202, a future electricity consumption time series prediction module 203, a future wind energy power shortage time series determination module 204, and an electric device electricity consumption distribution strategy generation module 205. Specifically,

the wind energy power time series obtainment module 201 is configured to calculate a wind energy power time series based on an obtained historical offshore wind speed time series, and meanwhile, obtain a historical actual wind energy power time series corresponding to the historical offshore wind speed time series.

The future wind energy power time series prediction module 202 is configured to perform fitting on the wind energy power time series and the historical actual wind energy power time series, obtain a historical fitted wind energy power time series, input the historical fitted wind energy power time series into a pre-trained wind energy power prediction model, and output a future wind energy power time series through the wind energy power prediction model.

The future electricity consumption time series prediction module 203 is configured to input, based on an obtained historical electricity consumption time series in an offshore aquaculture platform, the historical electricity consumption time series into a pre-trained electricity consumption prediction model, and output a future electricity consumption time series through the electricity consumption prediction model.

The future wind energy power shortage time series determination module 204 is configured to determine a future wind energy power shortage time series based on the future wind energy power time series and the future electricity consumption time series.

The electric device electricity consumption distribution strategy generation module 205 is configured to obtain priorities of all electric devices in the offshore aquaculture platform, sequence all the electric devices based on the priorities, obtain an electric device sequence, and generate an electric device electricity consumption distribution strategy based on the future wind energy power shortage time series and the electric device sequence.

In one embodiment, the electric device electricity consumption distribution strategy generation module 205 is configured to generate the electric device electricity consumption distribution strategy based on the future wind energy power shortage time series and the electric device sequence, and specifically, determine, based on the future wind energy power shortage time series, a plurality of periods of future wind energy power shortage time and shortage wind energy power corresponding to each period of future wind energy power shortage time; obtain an electricity consumption demand corresponding to each of the electric devices in the electric device sequence, and compare an electricity consumption demand corresponding to a last electric device in the electric device sequence with the shortage wind energy power corresponding to the plurality of periods of future wind energy power shortage time; obtain, in a case where the electricity consumption demand corresponding to the last electric device is not less than the shortage wind energy power, target future wind energy power shortage time corresponding to the shortage wind energy power, delete the last electric device from the electric device sequence, obtain a first adjusted electric device sequence, and determine an electricity consumption distribution object corresponding to the target future wind energy power shortage time based on the first adjusted electric device sequence; or, obtain, in a case where the electricity consumption demand corresponding to the last electric device is less than the shortage wind energy power, an adjacent electric device of the last electric device, calculate a total electricity consumption demand of the last electric device and the adjacent electric device, sequentially increase, in a case where the total electricity consumption demand is less than the shortage wind energy power, a quantity of the adjacent electric devices until a total electricity consumption demand of the last electric device and a target quantity of adjacent electric devices is not less than the shortage wind energy power, delete the last electric device and the target quantity of adjacent electric devices from the electric device sequence, obtain a second adjusted electric device sequence, and determine the electricity consumption distribution object corresponding to the target future wind energy power shortage time based on the second adjusted electric device sequence.

In one embodiment, the wind energy power time series obtainment module 201 is configured to calculate a wind energy power time series based on an obtained historical offshore wind speed time series, and specifically, obtain a plurality of historical offshore wind speeds in a preset historical time period, and arrange the plurality of historical offshore wind speeds in a time sequence, to obtain the historical offshore wind speed time series; separately input each of the historical offshore wind speeds in the historical offshore wind speed time series into a preset wind energy density calculation formula, obtain a historical offshore wind energy density corresponding to each of the historical offshore wind speeds, and generate a historical offshore wind energy density time series corresponding to the historical offshore wind speed time series; and extract a target historical offshore wind energy density corresponding to a historical time point from the historical offshore wind energy density time series, extract a target historical offshore wind speed corresponding to the historical time point from the historical offshore wind speed time series, substitute the target historical offshore wind energy density and the target historical offshore wind speed into a preset wind energy power calculation formula, obtain wind energy power corresponding to the historical time point, and generate a wind energy power time series based on the wind energy power corresponding to the historical time point.

In one embodiment, the wind energy density calculation formula is shown as follows:

$$W = {rAv}^{3} / 2.$$

In the formula, W denotes an offshore wind energy density, r denotes an air density, A denotes a swept area of a wind turbine blade, and v denotes an offshore wind speed.

In one embodiment, the wind energy power calculation formula is shown as follows:

$$P = WsA .$$

In the formula, P denotes the wind energy power, W denotes the offshore wind energy density, s denotes conversion efficiency of a wind energy converter, and A denotes the swept area of the wind turbine blade.

In one embodiment, the future wind energy power time series prediction module 201 is configured to perform fitting on the wind energy power time series and the historical actual wind energy power time series, and obtain the historical fitted wind energy power time series, and specifically, calculate total wind energy power corresponding to the wind energy power time series, and calculate average wind energy power corresponding to the wind energy power time series based on a wind energy power data point quantity in the wind energy power time series and the total wind energy power; calculate total historical actual wind energy power corresponding to the historical actual wind energy power time series, and calculate average historical actual wind energy power corresponding to the historical actual wind energy power time series based on a wind energy power data point quantity in the historical actual wind energy power time series and the total historical actual wind energy power; calculate a first difference between the average wind energy power and the average historical actual wind energy power, average, in a case where the first difference is not greater than a preset difference threshold, the wind energy power time series and the historical actual wind energy power time series, and obtain the historical fitted wind energy power time series; or, perform, in a case where the first difference is greater than the preset difference threshold, weighted average processing on the wind energy power time series and the historical actual wind energy power time series, and obtain the historical fitted wind energy power time series.

In one embodiment, a training process of the wind energy power prediction model specifically includes the following steps: an initial wind energy power prediction model is set, where the initial wind energy power prediction model includes a first prediction layer and a second prediction layer, and the first prediction layer is connected to the second prediction layer; wind energy power time series samples corresponding to identical days in a plurality of preset historical years and a meteorological time series sample corresponding to each of the wind energy power time series samples are obtained; the wind energy power time series sample corresponding to a first preset year is used as input of the first prediction layer, and the meteorological time series sample corresponding to a second preset year is used as output of the first prediction layer; and the output of the first prediction layer is used as output of the second prediction layer, the wind energy power time series sample corresponding to the second preset year is used as the output of the second prediction layer, model training is performed on the initial wind energy power prediction model until the model converges or reaches a preset iteration number, and the wind energy power prediction model is obtained. The second preset year is a next year of the first preset year.

In one embodiment, the future wind energy power shortage time series determination module 204 is configured to determine the future wind energy power shortage time series based on the future wind energy power time series and the future electricity consumption time series, and specifically, extract target future wind energy power and target future electricity consumption corresponding to each target time point from the future wind energy power time series and the future electricity consumption time series, and separately compare the target future wind energy power and the target future electricity consumption corresponding to an identical target time point; calculate, in a case where the target future wind energy power is less than the target future electricity consumption, a wind energy power shortage value based on the target future wind energy power and the target future electricity consumption, and use the wind energy power shortage value as a sequence value corresponding to a current time point; calculate, in a case where the target future wind energy power is not less than the target future electricity consumption, a wind energy power adequacy value based on the target future wind energy power and the target future electricity consumption, and use the wind energy power adequacy value as the sequence value corresponding to the current time point; integrate sequence values corresponding to all target time points to obtain a wind energy power surplus-deficit time series, traverse each sequence value in the wind energy power surplus-deficit time series one by one, and retain, in a case where the sequence value that is the wind energy power shortage value is traversed and no wind energy power adequacy value exists before the wind energy power shortage value, the wind energy power shortage value; and obtain, in a case where the sequence value that is the wind energy power shortage value is traversed and the wind energy power adequacy value exists before the wind energy power shortage value, the wind energy power adequacy value before the wind energy power shortage value, adjust the wind energy power shortage value based on the wind energy power adequacy value, obtain an adjusted sequence value, and determine the future wind energy power shortage time series until traversing of the wind energy power surplus-deficit time series is completed.

In one embodiment, the electric device electricity consumption distribution strategy generation module 205 is configured to obtain the priorities of all the electric devices in the offshore aquaculture platform, and specifically, obtain respective use degrees of all the electric devices, and set respective first weight values for all the electric devices based on the use degrees; obtain all first electric devices having an identical initial weight value, and set respective second weight values for all the first electric devices based on respective electricity consumption demands of all the first electric devices; and determine the respective priorities of all the electric devices based on the first weight values and the second weight values.

The system for utilizing wind energy in mariculture can implement the method for utilizing wind energy in mariculture according to the method embodiments. The options in the method embodiments are also applicable to the embodiment, and will not be described in detail herein.

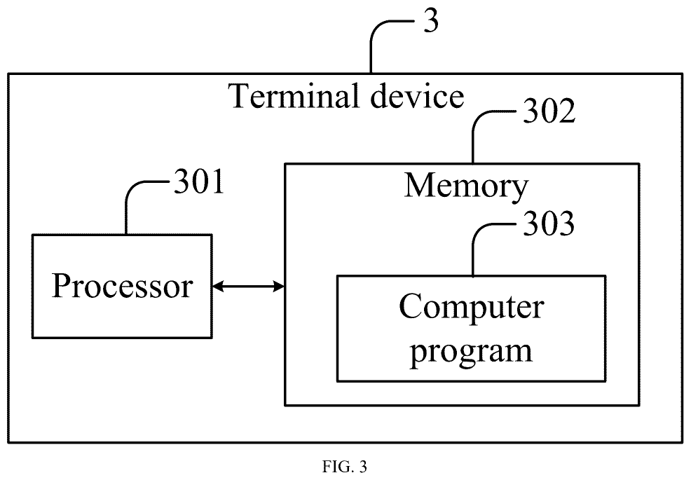

FIG. 3 is a schematic structural diagram of a terminal device. As shown in FIG. 3, the terminal device 3 of the embodiment includes at least one processor 301 (only one processor is shown in FIG. 3), a memory 302, and a computer program 303 stored in the memory 302 and runnable on the at least one processor 301. When the processor 301 executes the computer program 303, steps in any one of the method embodiments are implemented.

The terminal device 3 may be a computing device such as a smart phone, a notebook computer, a tablet computer, and a desktop computer. The terminal device 3 may include, but is not limited to, the processor 301 and the memory 302. Those skilled in the art can understand that FIG. 3 is only illustrative of the terminal device 3 and does not limit the terminal device 3. More or fewer components may be included than those shown in the figure, some components may be combined, or different components may be included. For example, an input/output device, a network access device and other devices may be included.

The processor 301 may be a central processing unit (CPU). Or, the processor 301 may be another general-purpose processor, a digital signal processor (DSP), an application specific integrated circuit (ASIC), a field-programmable gate array (FPGA) or another programmable logic device, a discrete gate or a transistor logic device, a discrete hardware component, etc. The general-purpose processor may be a microprocessor, or the processor may be any conventional processor or another processor.

In some embodiments, the memory 302 may be an internal storage unit of the terminal device 3, and for example, a hard disk or an internal memory of the terminal device 3. In some other embodiments, the memory 302 may be an external storage device of the terminal device 3, such as a plug-in hard disk, a smart media card (SMC), a secure digital (SD) card, a flash card or the like provided on the terminal device 3. Further, the memory 302 may alternatively include an internal storage unit and an external storage device of the terminal device 3. The memory 302 is configured to store an operating system, an application program, BootLoader, data, and other programs, such as a program code of a computer program. Or, the memory 302 may be configured to temporarily store output data or to-be-output data.

In addition, an embodiment of the present disclosure further provides a computer-readable storage medium. The computer-readable storage medium stores a computer program. When the computer program is executed by a processor, steps in any one of the method embodiments are implemented.

In the plurality of embodiments provided by the present disclosure, it can be understood that each block in the flowchart or block diagram may represent one module, one program segment or part of codes that includes one or more executable instructions configured to achieve specified logical functions. Or, it should be noted that, in some alternative implementations, the functions noted in the blocks may alternatively occur in an order different from that in the accompanying drawings. For example, the functions represented by two continuous blocks may be actually implemented basically in parallel, or may be implemented in reverse sequences, which depends on the involved functions.

If the function is achieved in a form of a software function module and sold or used as an independent product, the function may be stored in one computer-readable storage medium. Based on such understanding, the technical solution of the present disclosure can be embodied in a form of a software product in essence, in part that contributes to the prior art, or in part of the technical solution. The computer software product is stored in one storage medium, and includes a plurality of instructions to make one terminal device execute all or some steps of the method of each embodiment of the present disclosure. The storage medium includes: a universal serial bus flash drive, a mobile hard disk, a read-only memory (ROM), a random access memory (RAM), a magnetic disk, an optical disk, and other media capable of storing program codes.

In conclusion, in the method and system for utilizing wind energy in mariculture according to the present disclosure, fitting is performed on the wind energy power time series and the historical actual wind energy power time series, the historical fitted wind energy power time series is obtained, the historical fitted wind energy power time series is input into the wind energy power prediction model, and the future wind energy power time series is output; the obtained historical electricity consumption time series is input into the electricity consumption prediction model, and the future electricity consumption time series is output; the future wind energy power shortage time series is determined based on the future wind energy power time series and the future electricity consumption time series; and all the electric devices in the offshore aquaculture platform are sequenced based on the priorities, the electric device sequence is obtained, and the electric device electricity consumption distribution strategy is generated based on the future wind energy power shortage time series and the electric device sequence. Compared with the prior art, the technical solution of the present disclosure can optimize management and scheduling of the electric devices and improve energy utilization efficiency.

What are described above are merely preferred implementations of the present disclosure. It should be noted that those of ordinary skill in the art can also make some improvements and substitutions without departing from the technical principle of the present disclosure, and these improvements and substitutions should fall within the protection scope of the present disclosure.

1. A method for utilizing wind energy in mariculture, comprising:
calculating a wind energy power time series based on an obtained historical offshore wind speed time series, and meanwhile, obtaining a historical actual wind energy power time series corresponding to the historical offshore wind speed time series;
performing fitting on the wind energy power time series and the historical actual wind energy power time series, obtaining a historical fitted wind energy power time series, inputting the historical fitted wind energy power time series into a pre-trained wind energy power prediction model, and outputting a future wind energy power time series through the wind energy power prediction model;
inputting, based on an obtained historical electricity consumption time series in an offshore aquaculture platform, the historical electricity consumption time series into a pre-trained electricity consumption prediction model, and outputting a future electricity consumption time series through the electricity consumption prediction model;
determining a future wind energy power shortage time series based on the future wind energy power time series and the future electricity consumption time series; and
obtaining priorities of all electric devices in the offshore aquaculture platform, sequencing all the electric devices based on the priorities, obtaining an electric device sequence, and generating an electric device electricity consumption distribution strategy based on the future wind energy power shortage time series and the electric device sequence, wherein
the generating an electric device electricity consumption distribution strategy based on the future wind energy power shortage time series and the electric device sequence specifically comprises:
determining, based on the future wind energy power shortage time series, a plurality of periods of future wind energy power shortage time and shortage wind energy power corresponding to each period of future wind energy power shortage time;
obtaining an electricity consumption demand corresponding to each of the electric devices in the electric device sequence, and comparing an electricity consumption demand corresponding to a last electric device in the electric device sequence with the shortage wind energy power corresponding to the plurality of periods of future wind energy power shortage time;
obtaining, in a case where the electricity consumption demand corresponding to the last electric device is not less than the shortage wind energy power, target future wind energy power shortage time corresponding to the shortage wind energy power, deleting the last electric device from the electric device sequence, obtaining a first adjusted electric device sequence, and determining an electricity consumption distribution object corresponding to the target future wind energy power shortage time based on the first adjusted electric device sequence; or,
obtaining, in a case where the electricity consumption demand corresponding to the last electric device is less than the shortage wind energy power, an adjacent electric device of the last electric device, calculating a total electricity consumption demand of the last electric device and the adjacent electric device, sequentially increasing, in a case where the total electricity consumption demand is less than the shortage wind energy power, a quantity of the adjacent electric devices until a total electricity consumption demand of the last electric device and a target quantity of adjacent electric devices is not less than the shortage wind energy power, deleting the last electric device and the target quantity of adjacent electric devices from the electric device sequence, obtaining a second adjusted electric device sequence, and determining the electricity consumption distribution object corresponding to the target future wind energy power shortage time based on the second adjusted electric device sequence; and
the calculating a wind energy power time series based on an obtained historical offshore wind speed time series specifically comprises:
obtaining a plurality of historical offshore wind speeds in a preset historical time period, and arranging the plurality of historical offshore wind speeds in a time sequence, to obtain the historical offshore wind speed time series;
separately inputting each of the historical offshore wind speeds in the historical offshore wind speed time series into a preset wind energy density calculation formula, obtaining a historical offshore wind energy density corresponding to each of the historical offshore wind speeds, and generating a historical offshore wind energy density time series corresponding to the historical offshore wind speed time series; and
extracting a target historical offshore wind energy density corresponding to a historical time point from the historical offshore wind energy density time series, extracting a target historical offshore wind speed corresponding to the historical time point from the historical offshore wind speed time series, substituting the target historical offshore wind energy density and the target historical offshore wind speed into a preset wind energy power calculation formula, obtaining wind energy power corresponding to the historical time point, and generating a wind energy power time series based on the wind energy power corresponding to the historical time point.

2. The method for utilizing wind energy in mariculture according to claim 1, wherein the wind energy density calculation formula is shown as follows:
$$W = {rAv}^{3} / 2 ,$$
in the formula, W denotes an offshore wind energy density, r denotes an air density, A denotes a swept area of a wind turbine blade, and v denotes an offshore wind speed; and
the wind energy power calculation formula is shown as follows:
$$P = WsA ,$$
in the formula, P denotes the wind energy power, W denotes the offshore wind energy density, s denotes conversion efficiency of a wind energy converter, and A denotes the swept area of the wind turbine blade.

3. The method for utilizing wind energy in mariculture according to claim 1, wherein the performing fitting on the wind energy power time series and the historical actual wind energy power time series, and obtaining a historical fitted wind energy power time series specifically comprise:
calculating total wind energy power corresponding to the wind energy power time series, and calculating average wind energy power corresponding to the wind energy power time series based on a wind energy power data point quantity in the wind energy power time series and the total wind energy power;
calculating total historical actual wind energy power corresponding to the historical actual wind energy power time series, and calculating average historical actual wind energy power corresponding to the historical actual wind energy power time series based on a wind energy power data point quantity in the historical actual wind energy power time series and the total historical actual wind energy power;
calculating a first difference between the average wind energy power and the average historical actual wind energy power, averaging, in a case where the first difference is not greater than a preset difference threshold, the wind energy power time series and the historical actual wind energy power time series, and obtaining the historical fitted wind energy power time series; or,
performing, in a case where the first difference is greater than the preset difference threshold, weighted average processing on the wind energy power time series and the historical actual wind energy power time series, and obtaining the historical fitted wind energy power time series.

4. The method for utilizing wind energy in mariculture according to claim 1, wherein a training process of the wind energy power prediction model specifically comprises:
setting an initial wind energy power prediction model, wherein the initial wind energy power prediction model comprises a first prediction layer and a second prediction layer, and the first prediction layer is connected to the second prediction layer;
obtaining wind energy power time series samples corresponding to identical days in a plurality of preset historical years and a meteorological time series sample corresponding to each of the wind energy power time series samples; and
using the wind energy power time series sample corresponding to a first preset year as input of the first prediction layer, and using the meteorological time series sample corresponding to a second preset year as output of the first prediction layer; and using the output of the first prediction layer as output of the second prediction layer, using the wind energy power time series sample corresponding to the second preset year as the output of the second prediction layer, performing model training on the initial wind energy power prediction model until the model converges or reaches a preset iteration number, and obtaining the wind energy power prediction model, wherein the second preset year is a next year of the first preset year.

5. The method for utilizing wind energy in mariculture according to claim 1, wherein the determining a future wind energy power shortage time series based on the future wind energy power time series and the future electricity consumption time series specifically comprises:
extracting target future wind energy power and target future electricity consumption corresponding to each target time point from the future wind energy power time series and the future electricity consumption time series, and separately comparing the target future wind energy power and the target future electricity consumption corresponding to an identical target time point;
calculating, in a case where the target future wind energy power is less than the target future electricity consumption, a wind energy power shortage value based on the target future wind energy power and the target future electricity consumption, and using the wind energy power shortage value as a sequence value corresponding to a current time point;
calculating, in a case where the target future wind energy power is not less than the target future electricity consumption, a wind energy power adequacy value based on the target future wind energy power and the target future electricity consumption, and using the wind energy power adequacy value as the sequence value corresponding to the current time point;
integrating sequence values corresponding to all target time points to obtain a wind energy power surplus-deficit time series, traversing each sequence value in the wind energy power surplus-deficit time series one by one, and retaining, in a case where the sequence value that is the wind energy power shortage value is traversed and no wind energy power adequacy value exists before the wind energy power shortage value, the wind energy power shortage value; and
obtaining, in a case where the sequence value that is the wind energy power shortage value is traversed and the wind energy power adequacy value exists before the wind energy power shortage value, the wind energy power adequacy value before the wind energy power shortage value, adjusting the wind energy power shortage value based on the wind energy power adequacy value, obtaining an adjusted sequence value, and determining the future wind energy power shortage time series until traversing of the wind energy power surplus-deficit time series is completed.

6. The method for utilizing wind energy in mariculture according to claim 1, wherein the obtaining priorities of all electric devices in the offshore aquaculture platform specifically comprises:
obtaining respective use degrees of all the electric devices, and setting respective first weight values for all the electric devices based on the use degrees;
obtaining all first electric devices having an identical initial weight value, and setting respective second weight values for all the first electric devices based on respective electricity consumption demands of all the first electric devices; and
determining the respective priorities of all the electric devices based on the first weight values and the second weight values.

7. A system for utilizing wind energy in mariculture, comprising a wind energy power time series obtainment module, a future wind energy power time series prediction module, a future electricity consumption time series prediction module, a future wind energy power shortage time series determination module, and an electric device electricity consumption distribution strategy generation module, wherein
the wind energy power time series obtainment module is configured to calculate a wind energy power time series based on an obtained historical offshore wind speed time series, and meanwhile, obtain a historical actual wind energy power time series corresponding to the historical offshore wind speed time series;
the future wind energy power time series prediction module is configured to perform fitting on the wind energy power time series and the historical actual wind energy power time series, obtain a historical fitted wind energy power time series, input the historical fitted wind energy power time series into a pre-trained wind energy power prediction model, and output a future wind energy power time series through the wind energy power prediction model;
the future electricity consumption time series prediction module is configured to input, based on an obtained historical electricity consumption time series in an offshore aquaculture platform, the historical electricity consumption time series into a pre-trained electricity consumption prediction model, and output a future electricity consumption time series through the electricity consumption prediction model;
the future wind energy power shortage time series determination module is configured to determine a future wind energy power shortage time series based on the future wind energy power time series and the future electricity consumption time series;
the electric device electricity consumption distribution strategy generation module is configured to obtain priorities of all electric devices in the offshore aquaculture platform, sequence all the electric devices based on the priorities, obtain an electric device sequence, and generate an electric device electricity consumption distribution strategy based on the future wind energy power shortage time series and the electric device sequence;
the electric device electricity consumption distribution strategy generation module is configured to generate the electric device electricity consumption distribution strategy based on the future wind energy power shortage time series and the electric device sequence, and specifically:
determine, based on the future wind energy power shortage time series, a plurality of periods of future wind energy power shortage time and shortage wind energy power corresponding to each period of future wind energy power shortage time;
obtain an electricity consumption demand corresponding to each of the electric devices in the electric device sequence, and compare an electricity consumption demand corresponding to a last electric device in the electric device sequence with the shortage wind energy power corresponding to the plurality of periods of future wind energy power shortage time;
obtain, in a case where the electricity consumption demand corresponding to the last electric device is not less than the shortage wind energy power, target future wind energy power shortage time corresponding to the shortage wind energy power, delete the last electric device from the electric device sequence, obtain a first adjusted electric device sequence, and determine an electricity consumption distribution object corresponding to the target future wind energy power shortage time based on the first adjusted electric device sequence; or,
obtain, in a case where the electricity consumption demand corresponding to the last electric device is less than the shortage wind energy power, an adjacent electric device of the last electric device, calculate a total electricity consumption demand of the last electric device and the adjacent electric device, sequentially increase, in a case where the total electricity consumption demand is less than the shortage wind energy power, a quantity of the adjacent electric devices until a total electricity consumption demand of the last electric device and a target quantity of adjacent electric devices is not less than the shortage wind energy power, delete the last electric device and the target quantity of adjacent electric devices from the electric device sequence, obtain a second adjusted electric device sequence, and determine the electricity consumption distribution object corresponding to the target future wind energy power shortage time based on the second adjusted electric device sequence; and
the wind energy power time series obtainment module is configured to calculate a wind energy power time series based on an obtained historical offshore wind speed time series, and specifically, obtain a plurality of historical offshore wind speeds in a preset historical time period, and arrange the plurality of historical offshore wind speeds in a time sequence, to obtain the historical offshore wind speed time series; separately input each of the historical offshore wind speeds in the historical offshore wind speed time series into a preset wind energy density calculation formula, obtain a historical offshore wind energy density corresponding to each of the historical offshore wind speeds, and generate a historical offshore wind energy density time series corresponding to the historical offshore wind speed time series; and extract a target historical offshore wind energy density corresponding to a historical time point from the historical offshore wind energy density time series, extract a target historical offshore wind speed corresponding to the historical time point from the historical offshore wind speed time series, substitute the target historical offshore wind energy density and the target historical offshore wind speed into a preset wind energy power calculation formula, obtain wind energy power corresponding to the historical time point, and generate a wind energy power time series based on the wind energy power corresponding to the historical time point.
